(19) United States
(12) Patent Application Publication
(10) Pub. No.: US 2002/0120651 A1
(43) Pub. Date: Aug. 29, 2002

(54) Natural language search method and system for electronic books

(75) Inventors: James D. Pustejovsky, Arlington, MA (US); Robert Ingria, Somerville, MA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LingoMotors, Inc., Cambridge, MA (US)

(21) Appl. No.: 09/954,634

(22) Filed: Sep. 12, 2001

Related U.S. Application Data
(60) Provisional application No. 60/232,051, filed on Sep. 12, 2000.
(60) Provisional application No. 60/236,509, filed on Sep. 29, 2000.

(51) Int. Cl. G06F 15/00

(52) U.S. Cl. 707/513

(57) ABSTRACT

A method for querying information based upon a publication on a portable electronic display. The display has a microprocessing device coupled to memory. The display also has a region for outputting a portion or portions of the publication. The method includes displaying an electronic page from a plurality of pages on the display. The electronic page is a complete or portion of one of the plurality of pages. The method also includes selecting a term on the electronic page for which a query is to be performed; and querying the plurality of pages to uncover additional information about the term; and displaying a portion of or all of the additional information about the term.

### CROSS-REFERENCES TO RELATED APPLICATIONS

This application is a nonprovisional of and claims priority to each of the following, the entire disclosure of which are herein incorporated by reference for all purposes: U.S. Prov. Appl. No. 60/232,051 by James D. Pustejovsky, filed Sep. 12, 2000, entitled “NATURAL LANGUAGE” and U.S. Prov. Appl. No. 60/236,509 by John O'Neill et al., filed Sep. 29, 2000, entitled “SEARCH ENGINE METHOD AND SYSTEM.”

The following commonly owned previously filed applications are hereby incorporated by reference in their entirety for all purposes:

U.S. Prov. Appl. No. 60/110,190 by James D. Pustejovsky et al., filed Nov. 30, 1998, entitled “A NATURAL KNOWLEDGE ACQUISITION METHOD, SYSTEM, AND CODE”;

U.S. Prov. Appl. No. 60/163,345 by James D. Pustejovsky et al., filed Nov. 3, 1999, entitled, “A METHOD FOR USING A KNOWLEDGE ACQUISITION SYSTEM”;

U.S. Prov. Appl. No. 60/191,883 by James D. Pustejovsky, filed Mar. 23, 2000, entitled, “RETURNING DYNAMIC CATEGORIES IN SEARCH AND QUESTION-ANSWER SYSTEMS”;

U.S. Prov. Appl. No. 60/197,011 by James D. Pustejovsky, filed Apr. 13, 2000, entitled, “ANSWERING VERBAL QUESTIONS USING A NATURAL LANGUAGE SYSTEM”;

U.S. Prov. Appl. No. 60/226,413 by James D. Pustejovsky et. al, filed Aug. 18, 2000, entitled, “TYPE CONSTRUCTION AND THE LOGIC OF CONCEPTS”;

U.S. Prov. Appl. No. 60/228,616 by James D. Pustejovsky et. al, filed Aug. 28, 2000, entitled, “ANSWERING USER QUERIES USING A NATURAL LANGUAGE METHOD AND SYSTEM”;

U.S. Prov. Appl. No. 60/231,889 by James D. Pustejovsky, filed Sep. 11, 2000 entitled “METHOD AND APPARATUS FOR NATURAL LANGUAGE PROCESSING OF ELECTRONIC MAIL”;

U.S. application Ser. No. 09/449,845 by James D. Pustejovsky et al., filed Nov. 26, 1999, entitled “A NATURAL KNOWLEDGE ACQUISITION SYSTEM”;

U.S. application Ser. No. 09/433,630 by James D. Pustejovsky et al., filed Nov. 26, 1999, entitled, “A NATURAL KNOWLEDGE ACQUISITION METHOD”;

U.S. application Ser. No. 09/449,848 by James D. Pustejovsky et al,. filed Nov. 26, 1999, entitled, “A NATURAL KNOWLEDGE ACQUISITION SYSTEM COMPUTER CODE”;

U.S. application Ser. No. 09/662,510 by Robert J. P. Ingria et al., filed Sep. 15, 2000, entitled “ANSWERING USER QUERIES USING A NATURAL LANGUAGE METHOD AND SYSTEM”;

U.S. application Ser. No. 09/663,044 by Federica Busa et al., filed Sep. 15, 2000, entitled “NATURAL LANGUAGE TYPE SYSTEM AND METHOD”;

U.S. application Ser. No. 09/742,459 by James D. Pustejovsky et al, filed Dec. 19, 2000, entitled “METHOD FOR USING A KNOWLEDGE ACQUISITION SYSTEM”;

U.S. application Ser. No. 09/898,987 by Marcus E. M. Verhagen et al., filed Jul. 3, 2001, entitled “METHOD AND SYSTEM FOR ACQUIRING AND MAINTAINING NATURAL LANGUAGE INFORMATION”; and

U.S. application Ser. No. ______ by James D. Pustejovsky et al., filed concurrently herewith, entitled “METHOD AND APPARATUS FOR NATURAL LANGUAGE PROCESSING OF ELECTRONIC MAIL” (Attorney Docket No. 19497-000710US).

### BACKGROUND OF THE INVENTION

This invention generally relates to the field of information management. More particularly, the present invention provides a method and system for natural language processing of information in an electronic book. Merely by way of example, the invention has been applied to an electronic book. It would be recognized that the invention can also be applied to other sources of text information such as electronic file folders, and the like.

In the early days, the term book referred to a set of written sheets of skin or paper or tablets of wood or ivory-from early Germanic practice of carving runic characters on beech wood. The characters were limited and the carvings often difficult to make. Books later evolved to a set of written, printed, or blank sheets bound together into a volume. Many types of books exist. One of the most famous books has been based upon religion and is the Bible. Another book, which has a different flavor, that has been widely distributed is titled “Men Are from Mars, Women Are from Venus: A Practical Guide for Improving Communications and Getting What You Want in Your Relationships,” by John Gray, Ph.D, which is about the relationship between men and women. Still another type of book is an educational text book such as “The Language Instinct,” by Steven Pinker. All of these books have been written on sheets of paper, which are bound together into a volume.

To use such books, the user often begins at one end of the volume and reads the text to the other end of the volume. The user visually scans and reads each page, while flipping from one page to another page. Each page on the book often has written words for the user to read. Often times, the reader rests the book on a surface or holds the book using one or two hands, and flips each page with fingers on either hand. The process of reading a book often takes time and has not greatly changed since the early days of wood carvings. As can be seen, the process of reading a book is linear or serial from page to page. Accordingly, it is often difficult to refer to a specific fact or place in the book without paging through the volume of the book, which can be tedious and cumbersome.

From the above, it is seen that a technique for easily uncovering valuable information for an electronic textbook is highly desirable.

### SUMMARY OF THE INVENTION

According to the present invention, a technique including a method and device for operating an electronic book is provided. More particularly, the present invention provides a method and system for natural language processing of information in an electronic book. Merely by way of example, the invention has been applied to an electronic book. It would be recognized that the invention can also be applied to other sources of text information such as electronic file folders, and the like.

In a specific embodiment, the present invention provides a method for querying information based upon a publication on a portable electronic display. The display has a microprocessing device coupled to memory. The display also has a region for outputting a portion or portions of the publication. The method includes displaying an electronic page from a plurality of pages on the display. The electronic page is a complete or portion of one of the plurality of pages. The method also includes selecting a term on the electronic page for which a query is to be performed; and querying the plurality of pages to uncover additional information about the term; and displaying a portion of or all of the additional information about the term.

In another embodiment, the invention provides a user interface on a portable electronic display. The user interface is a display coupled to a microprocessing device and memory for storing text and graphics information. The text and graphics information is directed to an integrated document. The interface also has a content portion coupled to the display, which is capable of visually displaying a portion of the text and graphics information. The display has a process portion for entering data for searching. The process portion includes a search field and a display field. The search field is coupled to the display field.

There are many benefits to the present invention over conventional techniques. For example, the invention increases the probability that the user's query is correctly answered in some embodiments. The invention also provides an electronic medium that may include hyperlinks to other portions of the medium. In other aspects, the invention also provides ways of finding relationships between characters in a textbook or relationships between terms, which can be difficult using conventional textbooks. Depending upon the embodiment, one or more of these benefits may be achieved. These and other benefits will be described in more detail throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 illustrates a simplified diagram of an electronic book according to an embodiment of the present invention;

FIG. 2 is a simplified block diagram of the electronic book according to an embodiment of the present invention; and

FIG. 3 is a simplified flow diagram of a method according to an embodiment of the present invention.

### DESCRIPTION OF THE SPECIFIC EMBODIMENTS

According to the present invention, a technique including a method and device for operating an electronic book is provided. More particularly, the present invention provides a method and system for natural language processing of information in an electronic book.

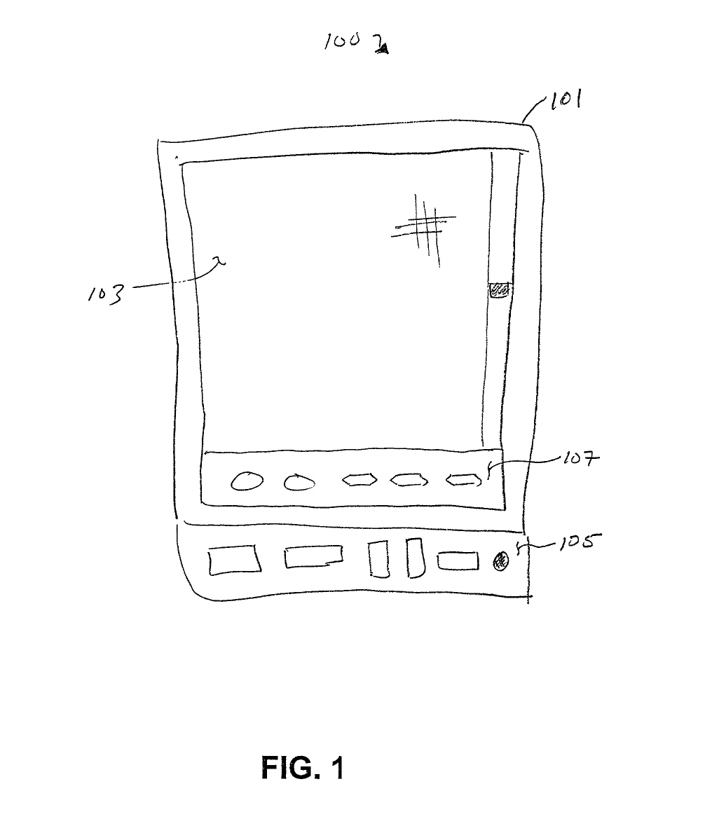

FIG. 1 illustrates a simplified diagram 100 of an electronic book according to an embodiment of the present invention. The diagram is merely an illustration and should not limit the scope of the claims herein. One of ordinary skill in the art would recognize many other variations, modifications, and alternatives. As shown, the electronic book 100 includes a variety of features such as housing 101, display 103, and user interface 105, which is in the form of buttons and typically includes an input device such as a pen input means. The electronic book 100 also has a graphical user interface 107. The specific design of the interface components are matters of ergonomics and human engineering considerations, and are not otherwise germane to the practice of the invention beyond providing a user with an interface to search the electronic book in accordance with embodiments of the invention.

As can be seen, the electronic book has numerous benefits. It is hand-held and easy to move. The book can be taken wherever the reader goes, similar to paper back books. The pages, bindings, and the like do not tear or wear. The book can also be lightweight and includes a back light for night reading. The book has a long life battery and large mass storage, which allows for thousands of pages of text to be stored and later retrieved. The book also has hypertext, which allows for easy navigation. When new text is desired, the user can download books directly from the Internet, and have them ready for reading within a predetermined amount of time, e.g., minutes. As merely an example, the user can retrieve books from sources such as Bames&Noble.com. Since the books do not require paper, the book is often much cheaper than their hardback or paperback counterparts.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

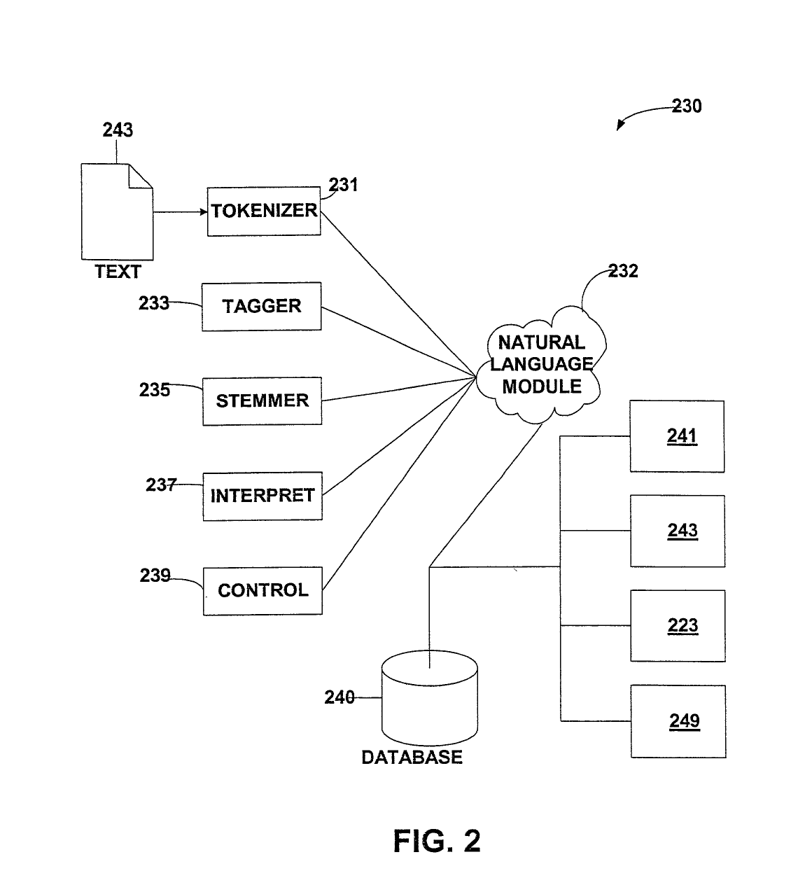

FIG. 2 is a simplified block diagram 230 of the electronic book according to an embodiment of the present invention. The diagram is merely an illustration and should not limit the scope of the claims herein. One of ordinary skill in the art would recognize many other variations, modifications, and alternatives. As shown, the electronic book 230 includes a common bus, which couples together various elements. The elements include a microprocessor device 241, a database 240, a temporary memory 243, a network interface device 223, a input/output interface 249, and various software modules, which define a natural language software engine 232. The engine 232 has a tokenizer 231, which is adapted to receive a stream of text information and separates the stream of text information (e.g., text book, query) into a plurality of tokens. The engine also includes a tagger 233 coupled to the tokenizer that is adapted to tag each token. A stemmer 235 coupled to the tagger also is included. The stemmer is adapted to stem each of the tagged tokens. The interpreter is coupled to the stemmer. The interpreter 237 is adapted to form an object including syntactic information and semantic information from each of the stemmed, tagged tokens. The engine also has control 239, which couples to the other elements. The book includes a relational or objected oriented or mixed database 240, e.g., coupled to the engine on the processor. The engine is adapted to form a knowledge base from a stream of text information 243. The knowledge base has a plurality of objects that populate the database.

The engine is adapted to retrieve from the knowledge base an answer to a query by the user. Here, the query can be in the form of text 243. In another specific embodiment of the present invention a list of relevant documents in response to a user query is returned. These documents may be ranked according to relevance, and also categorized dynamically into relevant classifications and sub-classifications, as motivated (or directed) by the content of a query. These “related categories” allow for a more natural and intuitive navigability of the document set returned by a query than conventional search technologies allow. The related categories are not static or pre-defined labels assigned to documents, but are computed dynamically as the result of two steps:

1. The documents are processed by the natural language processing system such as described in U.S. application Ser. No. 09/449,845, which has been incorporated herein by reference, and relevant entities and relations are stored in the database.

2. The query is processed by the natural language processing system and the entities and relations are represented in a normalized logical form.

The semantic form (normalized logical form) for the query is matched against the database; both exact matches (if present) and dynamically computed related categories are returned. A further description is given in U.S. Prov. Appl. Nos. 60/163,345 and 60/191,883, and U.S. application Ser. No. 09/449,848, all of which are have been incorporated herein by reference.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

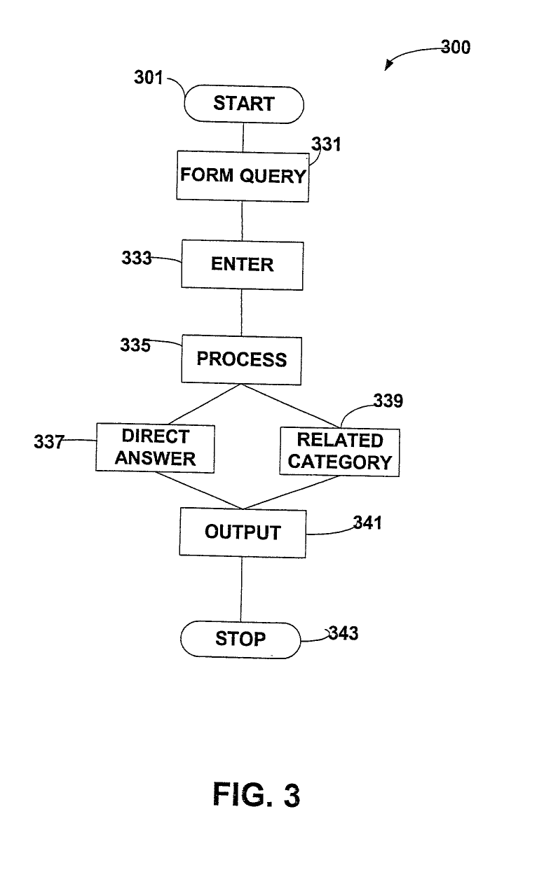

FIG. 3 is a simplified flow diagram 300 of a method according to an embodiment of the present invention. The diagram is merely an illustration and should not limit the scope of the claims herein. One of ordinary skill in the art would recognize many other variations, modifications, and alternatives. As shown, the method begins at block 301. Here, the electronic book receives a query (block 331), which is formed, from the user. The query is made by a user input device, e.g., electronic pen, keyboard, microphone, etc. In a specific embodiment, the query is provided in textual form, which is entered, block 333. The textual query is sent to the natural language system were the query is processed (block 335). In a specific embodiment, two different forms of answers are provided by the natural language system: direct answer(s) to the query (block 337) and related categories to the query (block 339). The direct answer(s), block 337, is sent back to the user, block 341, from the database to a display on the electronic book. If related categories (block 339) are provided, then they may be sent in textual form from the database to the display of the electronic book. The user could then select to view sub-categories or documents. In another embodiment, the related categories may be given in verbal rather than textual form and the user may select a sub-category or document via verbal command and have, for example, the document read to her/him.

The following example illustrates how the user may use one embodiment of the present invention. Here, the electronic book stores daily news paper information and can be used as a newspaper. The electronic book is also coupled to a server through a wired or wireless medium, which transfers information through, for example, a world wide network of computers such as an internet or the Internet. The user over her microphone, which is coupled to the book, would ask: “What did the S&P stock index do?.” This verbal question would be converted into its textual form, i.e., “What did the S&P stock index do?,” and sent to the natural language system 160. Alternatively, the user merely types in the request through a keyboard or pen-based computing device to the electronic book. This textual query would go through the stages including tagging and tokenization to yield:

What/WP did/VBD the/DT S&P500/NNP stock/NN index/NN do/VB ?/.

and would produce a semantic representation of the following form:

[UtteranceLexLF
type: [[Question]]
illocutionaryForce: #WhQuestion
content: [FunctionLexLF

type: [[QueryDo]]
predicateStem: ’do’
complements: (#Subject -> [EntityLexLF

type: [[Abstract Object]]
value: ’S&P500 stock index’
quantification: [QuantifierLexLF

type: [[Abstract Object]]
value: ’The’]]

#DirectObject -> [EntityLexLF

```
  type: [[Entity]]
  value: ’What’
  quantification: [QuantifierLexLF
```

type: [[Entity]]
value: ’what’
quantifier: #Wh]])]]

There are several features of this semantic form. First, the semantics of the interrogative pronoun ‘What’ is interpreted in its ‘logical’ position, i.e. as the direct object of the main verb ‘do’. Second, the semantic representation of ‘What’ includes a QuantifierLexLF that has #Wh as the value of its #quantifier. This indicates that this is the logical argument that is being asked about in this query.

Semantic representations for content queries of this type are processed for database lookup in the following manner.

First, the EntityID of the subject is retrieved:

select EntityID from Entities where CanonicalName=‘S&P500 stock index’

This will retrieve the EntityID 5230, which is then used to construct a select statement on the Relations table:

select * from Relations where Subject=5230

This will retrieve the row:

(776,23,405,380,5230,null,5231,‘36.46’,0,0,null,0,null,0,null,0)

Finally, for presentation to the user, the system will use this information to retrieve the sentence:

The S&P500 stock index rose 36.46 points.

i.e., the sentence at offset position 380, in the document with DocumentID 405, whose filename is ‘0000077400’. This information is passed to the book in the format:

<DISPLAY-FULL-OBJECT “”
{ “Reuters”
“http://199.103.231.59/demo-

code/source.pl/display=0000077400,380#380”

“The S&P500 stock index rose 36.46 points.” } { } >

which contains the source of the response text, an address that points to the complete source document, and the actual response text.

The natural language system may retrieve the complete source document of the given address and pass both the answer to the query (“What did the S&P stock index do?”), i.e., “The S&P500 stock index rose 36.46 points,” as well the complete source document text to a server, which contains the full source information. The server would then convert the answer from text to voice and the user would hear on a speaker on the electronic book: “The S&P500 stock index rose 36.46 points.” Alternatively, the text could be displayed on the electronic book. The user could be prompted to request the source of the information with a prompt such as: “If you want to hear the complete source of the answer, press #.” If the user presses “#,” the server would then convert the source text to voice and send it to the user's book.

The above embodiments illustrate an embodiment of a natural language system that may be used in responding to voice or text from a remote user with a wireless connection, an Internet telephone user, a landline telephone user, or the like. Other embodiments of natural language systems that may be used in the present invention are described in U.S. Pat. No. 5,794,050 in the names of Dahlgren et al., LexiGuide products, e.g., Web or Surfer or Expert, of LexiQuest, Inc, Ask Jeeves, Inc. question and answering product, vReps of Neuromedia, Inc., ALife-SmartEngine of Artificial Life, Inc., and the like.

FIG. 4 is a simplified flow diagram 400 of an alternative method according to an embodiment of the present invention. The diagram is merely an illustration and should not limit the scope of the claims herein. One of ordinary skill in the art would recognize many other variations, modifications, and alternatives.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Although the above functionality has generally been described in terms of specific hardware and software, it would be recognized that the invention has a much broader range of applicability. For example, the software functionality can be further combined or even separated. Similarly, the hardware functionality can be further combined, or even separated. The software functionality can be implemented in terms of hardware or a combination of hardware and software. Similarly, the hardware functionality can be implemented in software or a combination of hardware and software. Any number of different combinations can occur depending upon the application.

Many modifications and variations of the present invention are possible in light of the above teachings. Therefore, it is to be understood that within the scope of the appended claims, the invention may be practiced otherwise than as specifically described.

What is claimed is:

1. A method for querying information based upon a publication on a portable electronic display, the display comprising a microprocessing device coupled to memory, the display also comprising a display for outputting a portion or portions of the publication, the method comprising:
displaying an electronic page from a plurality of pages on the display, the electronic page being a complete or portion of one of the plurality of pages;
selecting a term on the electronic page for which a query is to be performed;
querying the plurality of pages to uncover additional information about the term; and
displaying a portion of or all of the additional information about the term.

2. The method of claim 1 wherein the plurality of pages define a document selected from a text book, a technical book, a tutorial, a fiction story, or a non-fiction story.

3. The method of claim 1 wherein the electronic page comprises XML annotation.

4. The method of claim 1 wherein the electronic page comprises tags to annotate the electronic page.

5. The method of claim 1 wherein the querying comprising identifying a tag directed to the additional information and displaying a content associated with the tag on the display.

6. The method of claim 1 wherein the querying comprises searching for a tag and content related to the additional information.

7. The method of claim 1 wherein the querying comprises entering a natural language logic form for the query.

8. The method of claim 1 wherein the querying comprises using a look up table for identifying the additional information.

9. The method of claim 1 wherein the additional information comprises a time line of events of a character or feature through the plurality of pages.

10. The method of claim 1 wherein the additional information comprises one or more relations of the term.

11. The method of claim 1 wherein the display and the plurality of pages define an electronic book.

12. The method of claim 1 wherein the querying searches data in the memory.

13. The method of claim 1 wherein the selecting is provided by a touch screen element coupled to the display.

14. The method of claim 1 wherein the selecting is provided by a key pad coupled to the display.

15. The method of claim 1 wherein the selecting is provided by a pen computing interface coupled to the display.

16. A user interface on a portable electronic display, the user interface comprising:
a display coupled to a microprocessing device and memory for storing text and graphics information, the text and graphics information being directed to an integrated document;
a content portion coupled to the display, the content portion being capable of visually displaying a portion of the text and graphics information;
a process portion for entering data for searching, the process portion including a search field and a display field, the search field being coupled to the display field.
